(19) United States
(12) Patent Application Publication
(10) Pub. No.: US 2025/0006186 A1
(43) Pub. Date: Jan. 2, 2025

(54) SPEECH-TO-TEXT CONVERSION METHOD AND APPARATUS, DEVICE, AND READABLE STORAGE MEDIUM

(71) Applicant: TENCENT TECHNOLOGY (SHENZHEN) COMPANY LIMITED, Shenzhen (CN)

(72) Inventors: Zhiyuan TANG, Shenzhen (CN); Shen HUANG, Shenzhen (CN); Shidong SHANG, Shenzhen (CN)

(21) Appl. No.: 18/886,702

(22) Filed: Sep. 16, 2024

Related U.S. Application Data
(63) Continuation of application No. PCT/CN2023/129540, filed on Nov. 3, 2023.

(30) Foreign Application Priority Data
Dec. 30, 2022 (CN) 202211740515.6

(51) Int. Cl. G10L 15/18; G06V 30/148; G06V 30/19; G10L 15/04; G10L 15/30

(52) U.S. Cl. CPC G10L 15/1815; G06V 30/153; G06V 30/191; G10L 15/04; G10L 15/30

(57) ABSTRACT

A speech-to-text conversion method includes: performing speech-to-text conversion on speech information to obtain a plurality of pieces of candidate text information; determining target appearance indicators corresponding to the plurality of pieces of candidate text information based on a screen image, the screen image being an image related to the speech information and displayed on a screen during generation of the speech information, and a target appearance indicator of one piece of the candidate text information representing a probability that the candidate text information corresponds to the speech information; selecting the candidate text information whose target appearance indicator meets a requirement from the plurality of pieces of candidate text information as converted text information of the speech information.

### CROSS-REFERENCES TO RELATED APPLICATIONS

This application is a continuation application of PCT Patent Application No. PCT/CN2023/129540, filed on Nov. 3, 2024, which claims priority to Chinese Patent Application No. 202211740515.6, entitled “SPEECH-TO-TEXT CONVERSION METHOD AND APPARATUS, DEVICE, AND READABLE STORAGE MEDIUM” filed with the China National Intellectual Property Administration on Dec. 30, 2022, the entire contents of both of which are incorporated herein by reference.

### FIELD OF THE TECHNOLOGY

Embodiments of the present disclosure relate to the field of computer technologies, and in particular, to a speech-to-text conversion technology.

### BACKGROUND OF THE DISCLOSURE

In an information sharing scenario such as a conference scenario or a teaching scenario, a speaker sometimes gives a speech to the audience. In this case, speech content of the speech may be converted into text, and the text is displayed to help the audience to understand the speech content. However, text obtained through speech-to-text conversion is not accurate sometimes. Therefore, how to accurately convert speech information into text information in the information sharing scenario becomes a problem to be urgently resolved.

### SUMMARY

The present disclosure provides a speech-to-text conversion method and apparatus, a device, and a readable storage medium, which can accurately convert speech information into text information in an information sharing scenario. The technical solutions include the following content.

According to an aspect, a speech-to-text conversion method is provided, performed by an electronic device, the method including: obtaining speech information to be converted and a screen image, the screen image being an image related to the speech information and displayed on a screen during generation of the speech information; performing speech-to-text conversion on the speech information to obtain a plurality of pieces of candidate text information; determining target appearance indicators corresponding to the plurality of pieces of candidate text information based on the screen image, a target appearance indicator of one piece of the candidate text information representing a probability that the one piece of candidate text information corresponds to the speech information; and selecting the candidate text information whose target appearance indicator meets a requirement from the plurality of pieces of candidate text information as converted text information of the speech information.

According to another aspect, a speech-to-text conversion apparatus is provided, including: an obtaining module, configured to obtain to-be-converted speech information and a screen image, the screen image being an image related to the speech information and displayed on a screen during generation of the speech information; a conversion module, configured to perform speech-to-text conversion on the speech information to obtain a plurality of pieces of candidate text information; a determining module, configured to determine target appearance indicators corresponding to the plurality of pieces of candidate text information based on the screen image, a target appearance indicator of one piece of the candidate text information representing a probability that the one piece of candidate text information corresponds to the speech information; and a selection module, configured to select the candidate text information whose target appearance indicator meets a requirement from the plurality of pieces of candidate text information as converted text information of the speech information.

According to another aspect, an electronic device is provided, including a processor and a memory, the memory storing at least one computer program, and the at least one computer program being loaded and executed by the processor to cause the electronic device to implement the speech-to-text conversion method according to any one of the foregoing aspects.

According to another aspect, a non-transitory computer-readable storage medium is further provided, having at least one computer program stored therein, the at least one computer program being loaded and executed by a processor, to cause an electronic device to implement the speech-to-text conversion method according to any one of the foregoing aspects.

The technical solutions provided in the present disclosure at least have the following beneficial effects:
In the technical solutions provided in the present disclosure, the screen image is an image related to the speech information and displayed on a screen during generation of the speech information. Therefore, the screen image and the speech information are highly correlated, and the screen image and the speech information both reflect a characteristic of a current information sharing scenario. The target appearance indicators of the plurality of pieces of candidate text information obtained after speech-to-text conversion is performed on the speech information are determined on the screen image. The target appearance indicator of the candidate text information represents a probability that the candidate text information corresponds to the speech information, so that the target appearance indicator of the candidate text information is related to the information sharing scenario, thereby improving the accuracy of the target appearance indicator of the candidate text information. Correspondingly, the converted text information of the speech information is determined based on the target appearance indicators of the plurality of pieces of candidate text information, so that high accuracy of the determined converted information can be ensured.

### BRIEF DESCRIPTION OF THE DRAWINGS

FIG. 1 is a schematic diagram of an implementation environment of a speech-to-text conversion method according to an embodiment of the present disclosure.

FIG. 2 is a flowchart of a speech-to-text conversion method according to an embodiment of the present disclosure.

FIG. 3 is a schematic diagram of an information sharing scenario according to an embodiment of the present disclosure.

FIG. 4 is a schematic diagram of a speech-to-text conversion model according to an embodiment of the present disclosure.

FIG. 5 is a schematic diagram of a masked language model according to an embodiment of the present disclosure.

FIG. 6 is a schematic diagram of a speech-to-text conversion method according to an embodiment of the present disclosure.

FIG. 7 is a schematic structural diagram of a speech-to-text conversion apparatus according to an embodiment of the present disclosure.

FIG. 8 is a schematic structural diagram of a terminal device according to an embodiment of the present disclosure.

FIG. 9 is a schematic structural diagram of a server according to an embodiment of the present disclosure.

### DESCRIPTION OF EMBODIMENTS

To make the objectives, technical solutions, and advantages of the present disclosure clearer, the following further describes implementations of the present disclosure in detail with reference to the accompanying drawings.

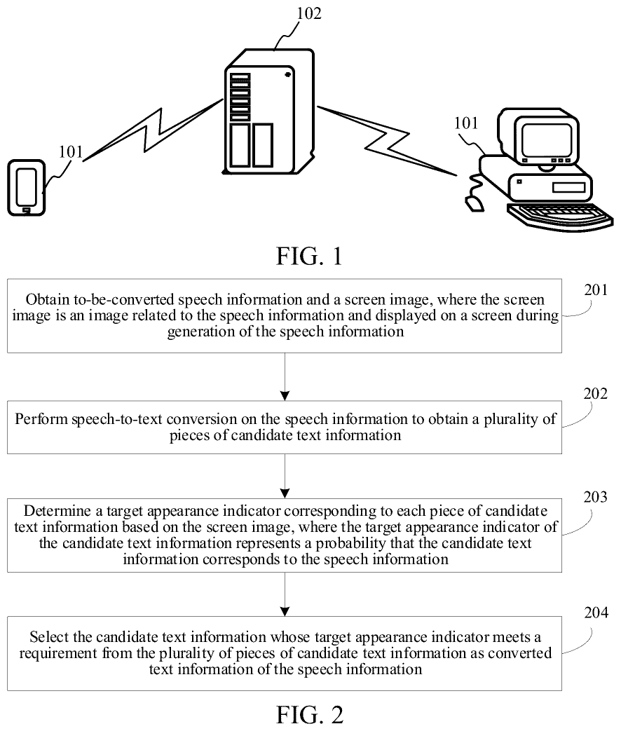

FIG. 1 is a schematic diagram of an implementation environment of a speech-to-text conversion method according to an embodiment of the present disclosure. As shown in FIG. 1, the implementation environment includes a terminal device 101 and a server 102. The speech-to-text conversion method in this embodiment of the present disclosure may be performed by the terminal device 101, or may be performed by the server 102, or may be performed by the terminal device 101 and the server 102 in cooperation.

The terminal device 101 may be a smartphone, a game console, a desktop computer, a tablet computer, a laptop portable computer, a smart television, a smart in-vehicle device, a smart speech interaction device, a smart home appliance, and the like. The server 102 may be any one of a server, a server cluster including a plurality of servers, a cloud computing platform, or a virtualization center. This is not limited in the embodiments of the present disclosure. The server 102 may be communicatively connected to the terminal device 101 through a wired network or a wireless network. The server 102 may have functions of data processing, data storage, data transmitting and receiving, and the like. This is not limited in the embodiments of the present disclosure. Quantities of terminal devices 101 and servers 102 are not limited, and there may be one or more terminal devices 101 and servers 102.

With the continuous development of information technologies, information sharing implemented based on the Internet is increasingly common. For example, conferences, teaching, and the like may all be shared based on the Internet. In an information sharing scenario, a speaker sometimes speaks some uncommon words to the audience, making it difficult for the audience to understand speech content. In this case, speech information of the speech may be converted into text information, and the text information is displayed to help the audience to understand the speech content. Based on this, how to accurately convert speech information into text information becomes a problem to be urgently resolved.

An embodiment of the present disclosure provides a speech-to-text conversion method. The method may be applied to the foregoing implementation environment shown in FIG. 1, so that speech information can be converted into accurate text information. A flowchart of a speech-to-text conversion method according to an embodiment of the present disclosure shown in FIG. 2 is used as an example. For ease of description, the terminal device 101 or the server 102 that performs the speech-to-text conversion method in this embodiment of the present disclosure is referred to as an electronic device, and the method may be performed by the electronic device. As shown in FIG. 2, the method includes the following operations.

Operation 201. Obtain to-be-converted speech information and a screen image, where the screen image is an image related to the speech information and displayed on a screen during generation of the speech information.

In an information sharing scenario, during a speech, a speaker may display material related to speech content to the audience on a screen. The material is displayed in a variety of manners. For example, the material is displayed in at least one manner such as a slide show, a video, a document, an image, and the like. The information sharing scenario includes a conference scenario, a teaching scenario, and the like.

During the speech of the speaker, a speech recording device such as a recorder or a mobile phone may record the speech of the speaker to obtain speech information, and the electronic device may obtain the speech information. For example, the electronic device may be the speech recording device. In this case, the electronic device may obtain the speech information through recording. Alternatively, the electronic device reads the speech information from the speech recording device by communicating with the speech recording device. Alternatively, the electronic device may transmit the obtained speech information to a server, so that the server can also obtain the speech information.

In a process that the speaker generates the speech information, the speaker displays the material related to the speech content on the screen. A screen recording device such as a camera or a mobile phone may record the material displayed on the screen to obtain a screen image, and the electronic device may obtain the screen image. For example, the electronic device may be the screen recording device. In this case, the electronic device may obtain the screen image through recording. Alternatively, the electronic device reads the screen image from the screen recording device by communicating with the screen recording device. Alternatively, the electronic device may transmit the obtained screen image to the server, so that the server can also obtain the screen image. The speech recording device and the screen recording device may be the same device or different devices.

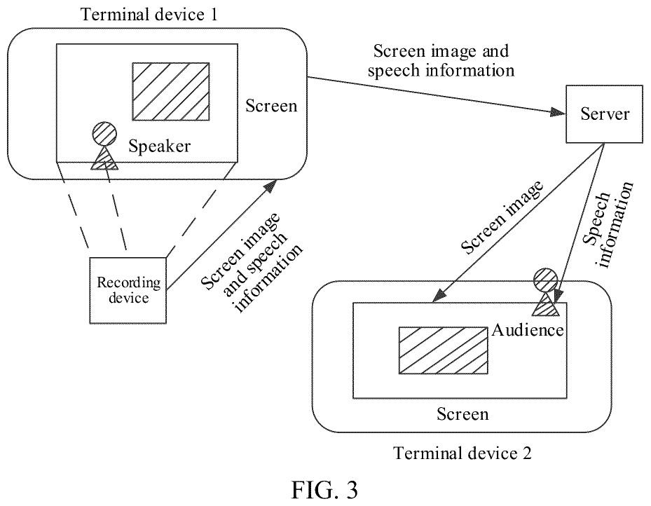

Referring to FIG. 3, which is a schematic diagram of an information sharing scenario according to an embodiment of the present disclosure. In the information sharing scenario, during a speech, a speaker displays material related to speech content on a screen of a terminal device 1. On one hand, a recording device records the speech of the speaker to obtain speech information. On the other hand, the recording device records the material displayed on the screen to obtain a screen image. The terminal device 1 may communicate with the recording device, and the recording device transmits the screen image and the speech information to the terminal device 1, so that the terminal device 1 obtains the screen image and the speech information.

The terminal device 1 may transmit the screen image and the speech information to the server, and the server transmits the screen image and the speech information to at least one terminal device 2. Processing manners of the terminal devices 2 are the same. The following uses one terminal device 2 as an example for description. On one hand, the terminal device 2 plays the speech information, so that the audience can hear the speech of the speaker. On the other hand, the terminal device 2 displays the screen image on a screen, so that the audience can see the material related to a topic of the speech.

Operation 202. Perform speech-to-text conversion on the speech information to obtain a plurality of pieces of candidate text information.

Speech-to-text conversion may be performed on the speech information in any speech-to-text conversion manner, to obtain the plurality of pieces of candidate text information. For example, an application program having a speech-to-text conversion function is installed on the electronic device, and the speech information is converted into the plurality of pieces of candidate text information through the speech-to-text conversion function. Alternatively, a readily-available speech-to-text conversion model may be directly obtained, or a first network model may be trained by using a first sample set to obtain a speech-to-text conversion model, and the electronic device invokes the speech-to-text conversion model to perform speech-to-text conversion on the speech information, to obtain the plurality of pieces of candidate text information.

A structure, a size, and the like of the speech-to-text conversion model are not limited in the embodiments of the present disclosure. For example, the speech-to-text conversion model may include at least one of a Transformer, a target detection algorithm (Conformer), a recurrent neural network (RNN), and the like.

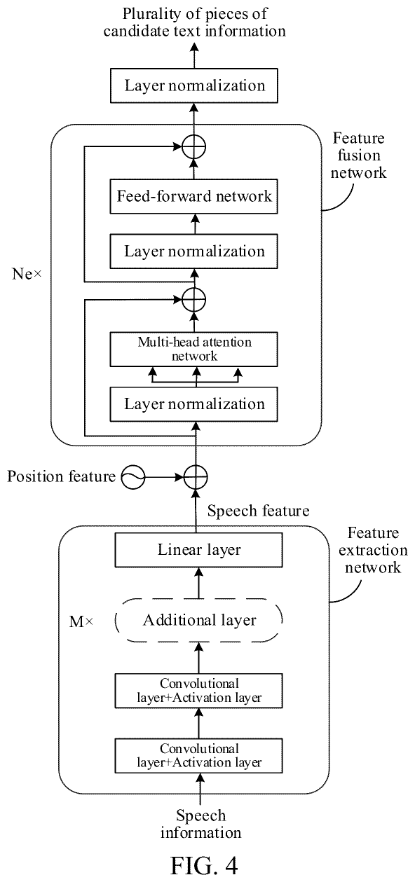

Referring to FIG. 4, which is a schematic diagram of a speech-to-text conversion model according to an embodiment of the present disclosure. The speech-to-text conversion model includes a feature extraction network and a feature fusion network. The speech information is inputted into the speech-to-text conversion model, and feature extraction is performed on the speech information through the feature extraction network, to obtain a speech feature. The speech feature and a position feature are spliced to obtain a spliced feature. The position feature herein is position information corresponding to each speech feature, and represents a corresponding position of the speech feature in the inputted speech information. The spliced feature is inputted into the feature fusion network, and the feature fusion network performs fusion processing on the spliced feature to obtain a fused feature. There is at least one feature fusion network. As shown in FIG. 4, Ne feature fusion networks are shown. The feature fusion networks are connected in series. An output of a previous feature fusion network is an input of a next feature fusion network, an input of the first feature fusion network is the spliced feature, and an output of the last feature fusion network is the fused feature. Layer normalization processing is performed on the fused feature by layer normalization, to obtain the plurality of pieces of candidate text information. Ne is a positive integer.

The feature extraction network includes at least one convolutional layer, at least one activation layer, and a linear layer. In addition, the feature extraction network may further include an additional layer. The additional layer may be any network layer such as a normalization layer, an attention layer, or a hidden layer. FIG. 4 shows that the feature extraction network includes two convolutional layers, two activation layers, M additional layers, and a linear layer, where M is a positive integer.

Any feature fusion network includes at least one layer normalization, a multi-head attention network, and a feed-forward network. FIG. 4 shows that the feature fusion network includes two layer normalizations, a multi-head attention network, and a feed-forward network. One layer normalization is skip-connected to the multi-head attention network, and the other layer normalization is skip-connected to the feed-forward network. That is, an input of one layer normalization (that is, an input of the feature fusion network) and an output of the multi-head attention network are spliced and then inputted to the other layer normalization, and an input of the other layer normalization and an output of the feed-forward network are spliced.

When the first network model is trained by using the first sample set to obtain the speech-to-text conversion model, structures of the first network model and the speech-to-text conversion model are the same, and there is only a difference in model parameters. The first sample set includes a plurality of pieces of sample speech information and a plurality of pieces of annotated text information corresponding to each piece of sample speech information. The plurality of pieces of sample speech information are inputted into the first network model. For each piece of sample speech information, feature extraction is performed on the sample speech information by using the feature extraction network to obtain a sample speech feature. The sample speech feature and a sample position feature are spliced to obtain a sample spliced feature. Fusion processing is performed on the sample spliced feature by using the feature fusion network to obtain a sample fused feature. Layer normalization processing is performed on the sample fused feature through the layer normalization to obtain a plurality of pieces of predicted text information corresponding to the sample speech information. A loss corresponding to the sample speech information is determined by using the plurality of pieces of annotated text information and the plurality of pieces of predicted text information corresponding to the sample speech information. The first network model is trained based on the losses corresponding to the plurality of pieces of sample speech information, to obtain the speech-to-text conversion model. For a speech-to-text conversion manner in which the electronic device invokes the speech-to-text conversion model to perform speech-to-text conversion on the speech information to obtain a plurality of pieces of candidate text information, reference may be made to the description related to FIG. 4. Details are not described herein again.

In an exemplary embodiment, Operation 202 includes Operation 2021 to Operation 2023.

Operation 2021. Perform segmentation on the speech information to obtain a plurality of speech segments.

A speech segmentation window and a window movement size may be obtained. The speech segmentation window is placed at a start position of the speech information, and segmentation is performed on the speech information based on the speech segmentation window, to obtain one speech segment corresponding to the speech segmentation window; the speech segmentation window is moved based on the window movement size, and segmentation is performed on the speech information based on the moved speech segmentation window, to obtain another speech segment corresponding to the speech segmentation window; and the speech segmentation window is moved again based on the window movement size, and segmentation is performed on the speech information based on the moved speech segmentation window, to obtain still another speech segment corresponding to the speech segmentation window, and so on until the speech segmentation window is moved to an end position of the speech information, so that a plurality of speech segments may be obtained.

A speech length corresponding to the speech segmentation window is greater than or equal to a speech length corresponding to the window movement size. When the speech length corresponding to the speech segmentation window is greater than the speech length corresponding to the window movement size, there is an overlapping part between two speech segments at adjacent positions in the speech information. For example, if the speech length corresponding to the speech segmentation window is 50 milliseconds, and the speech length corresponding to the window movement size is 30 milliseconds, a first speech segment corresponds to 0 millisecond to 50 milliseconds in the speech information, a second speech segment corresponds to 30 milliseconds to 80 milliseconds in the speech information, and a third speech segment corresponds to 60 milliseconds to 110 milliseconds in the speech information. An overlapping part between the first speech segment and the second speech segment is 30 milliseconds to 50 milliseconds, and an overlapping part between the second speech segment and the third speech segment is 60 milliseconds to 80 milliseconds.

Operation 2022. Perform speech-to-text conversion on each speech segment to obtain a character corresponding to the speech segment.

The character corresponding to the speech segment may be obtained by performing speech-to-text conversion on the speech segment. The character corresponding to the speech segment may be an empty character or at least one character. Characters corresponding to any two speech segments may be exactly the same, exactly different, partially the same, or partially different. For example, the first speech segment corresponds to a character “the”, the second speech segment corresponds to a character “the weather”, the third speech segment corresponds to an empty character, and a fourth speech segment corresponds to a character “is clear”.

Any speech segment may correspond to at least one character or word. For example, a speech segment may correspond to a word “vane”, a word “vain”, a word “vein”, and the like.

Operation 2023. Determine the plurality of pieces of candidate text information based on the characters corresponding to the plurality of speech segments.

One character may be selected from the at least one character corresponding to each speech segment. Integration is performed on the characters corresponding to the plurality of speech segments to obtain one piece of candidate text information. The integration includes adding punctuation marks, removing empty characters, removing duplicated characters, and the like. For example, the four speech segments sequentially correspond to the character “the”, the character “the weather”, an empty character, and the character “is clear”. By integrating the characters corresponding to the four speech segments, candidate text information “the weather is clear” may be obtained.

In some embodiments, when speech-to-text conversion is performed on the speech information by using the speech-to-text conversion model shown in FIG. 4, the speech information may be segmented into a plurality of speech segments, and for each speech segment, feature extraction is performed on the speech segment through the feature extraction network in the speech-to-text conversion model, to obtain a speech feature of the speech segment. The speech feature of the speech segment and a position feature of the speech segment are spliced, to obtain a spliced feature of the speech segment, where the position feature of the speech segment represents a position of the speech segment in the plurality of speech segments included in the speech information. Feature fusion is performed on the spliced feature of the speech segment through the feature fusion network in the speech-to-text conversion model, to obtain a fused feature of the speech segment. Layer normalization processing is performed on the fused feature of the speech segment by layer normalization, to obtain probabilities of the speech segment corresponding to a plurality of characters, and based on the probabilities of the speech segment corresponding to the plurality of characters, at least one character with a probability greater than a probability threshold is selected from the plurality of characters as the character corresponding to the speech segment. Further, one piece of candidate text information may be obtained based on one character corresponding to each speech segment. In this manner, a plurality of pieces of candidate text information may be determined.

In this way, through the foregoing manner, speech information is segmented to obtain a plurality of speech segments, speech-to-text conversion is performed by using a speech segment as a unit to obtain characters corresponding to the speech segments, and then a plurality of pieces of candidate text information are constructed based on the characters corresponding to the speech segments. In this way, high accuracy and reliability of the constructed candidate text information can be ensured, and the diversity of the constructed candidate text information can also be ensured.

Operation 203. Determine target appearance indicators corresponding to the plurality of pieces of candidate text information based on the screen image, where the target appearance indicator of the candidate text information represents a probability that the candidate text information corresponds to the speech information.

Because the screen image is displayed on a screen during generation of the speech information, the screen image is closely correlated with the speech information, and the screen image and the speech information jointly represent the speech content of the speaker. The probability that each piece of candidate text information corresponds to the speech information may be determined by using the screen image, so that converted text information of the speech information is determined based on the probability that each piece of candidate text information corresponds to the speech information, thereby improving the accuracy.

The target appearance indicator of the candidate text information represents a probability that the candidate text information corresponds to the speech information, and the probability that the candidate text information corresponds to the speech information may be understood as a probability that a real text representation form of the speech information is the candidate text information. For example, assuming that candidate text information corresponding to speech information includes “vane”, “vain”, and “vein”, if a target appearance indicator of the candidate text information “vane” is 0.6, a target appearance indicator of the candidate text information “vain” is 0.3, and a target appearance indicator of the candidate text information “vein” is 0.1, it indicates that a probability that the real text representation form of the speech information is “vane” is the greatest. The target appearance indicator of the candidate text information may also reflect a probability that the candidate text information appears in an information sharing scenario corresponding to the speech information.

In the embodiments of the present disclosure, the target appearance indicator of any piece of candidate text information is greater than or equal to 0. A larger target appearance indicator of the candidate text information indicates a higher probability that the candidate text information corresponds to the speech information, that is, a higher probability that the candidate text information appears in the information sharing scenario. In some embodiments, the target appearance indicator of the candidate text information is a probability value (that is, greater than or equal to 0 and less than or equal to 1), which may represent a probability that the candidate text information appears in the information sharing scenario.

In one embodiment, the electronic device may determine screen text information based on the screen image. The screen text information is text information related to the screen image, and may be, for example, text included in the screen image, or text configured for describing the screen image. Further, the target appearance indicator of each piece of candidate text information is determined based on the screen text information. To be specific, a probability that each piece of candidate text information actually corresponds to the speech information is measured by using the screen text information. In this way, the target appearance indicator of the candidate text information is determined based on the screen text information corresponding to the screen image, so that high accuracy of the determined target appearance indicator can be ensured.

Certainly, in an actual application, the electronic device may alternatively determine the target appearance indicator of each piece of candidate text information directly based on the screen image. For example, a neural network model for measuring a correlation between text information and an image may be invoked, and the screen image and the candidate text information are inputted into the neural network model. The neural network model measures a correlation between the inputted candidate text information and the inputted screen image, outputs a correlation parameter for representing the correlation, and uses the correlation parameter as the target appearance indicator of the candidate text information.

In one embodiment, the “determining screen text information based on the screen image” in Operation 203 includes Operation 2031 to Operation 2032.

Operation 2031. Perform image segmentation on the screen image to obtain at least one of a text image and an object image, where the text image reflects text displayed on the screen, and the object image reflects an object displayed on the screen.

In the embodiments of the present disclosure, the text and the object in the screen image are segmented to obtain the text image and the object image. The object image herein includes any type of image. For example, the object image may be an image of a flowchart, an image of an object, an image of an application program interface, and the like. For example, if the screen image includes a water cup and description text “a transparent water cup that is easy to carry”, the screen image may be segmented into an image including the water cup (that is, an object image) and an image including the description text “a transparent water cup that is easy to carry” (that is, a text image), to obtain multimodal information.

Image segmentation may be performed on the screen image in any image segmentation manner to obtain at least one of the text image and the object image. For example, an application program having an image segmentation function is installed on the electronic device, and the screen image is segmented into the text image and/or the object image through the image segmentation function. Alternatively, a readily-available image segmentation model may be directly obtained, or a second network model may be trained by using a second sample set to obtain an image segmentation model, and the electronic device invokes the image segmentation model to segment the screen image into the text image and/or the object image.

A structure, a size, and the like of the image segmentation model are not limited in the embodiments of the present disclosure. When the second network model is trained by using the second sample set to obtain the image segmentation model, model structures of the image segmentation model and the second network model are the same, and there is only a difference in model parameters. The second sample set includes a plurality of sample screen images, and annotated text images and/or annotated object images corresponding to the sample screen images. Any sample screen image may be inputted into the second network model, a predicted text image and/or a predicted object image corresponding to the sample screen image are determined through the second network model, and a loss corresponding to the sample screen image is determined based on the predicted text image and/or the predicted object image corresponding to the sample screen image and the annotated text image and/or the annotated object image corresponding to the sample screen image. The second network model is trained based on the losses corresponding to the sample screen images, to obtain the image segmentation model. The electronic device invokes the image segmentation model to perform image segmentation on the screen image to obtain the text image and/or the object image.

Operation 2032. Determine screen text information based on at least one of the text image and the object image.

Because the text image and the object image are obtained by segmenting the screen image, both the text image and the object image are strongly correlated with the speech information, and the text image, the object image, and the speech information jointly represent the speech content of the speaker, that is, the information sharing scenario. Therefore, the screen text information may be determined through at least one of the text image and the object image, to determine a probability that each piece of candidate text information appears in the information sharing scene based on the screen text information.

In an exemplary embodiment, Operation 2032 is divided into Case A1 to Case A3 as follows.

Case A1. Determine the screen text information based on the text image. That is, the text image may be segmented from the screen image. In Case A1, the determining the screen text information based on the text image includes Operation A11 to Operation A13.

Operation A11. Perform text recognition on the text image to obtain first text information in the text image.

Text recognition may be performed on the text image in any text recognition manner, to obtain the first text information in the text image. For example, an application program having a text recognition function is installed on the electronic device, and text recognition is performed on the text image through the text recognition function. Alternatively, a readily-available text recognition model may be directly obtained, or a third network model may be trained by using a third sample set to obtain a text recognition model, and the electronic device invokes the text recognition model to perform text recognition on the text image.

A structure, a size, and the like of the text recognition model are not limited in the embodiments of the present disclosure. When the third network model is trained by using the third sample set to obtain the text recognition model, model structures of the text recognition model and the third network model are the same, and there is only a difference in model parameters. The third sample set includes a plurality of sample text images and annotated text information corresponding to the sample text images. Any sample text image may be inputted into the third network model, predicted text information corresponding to the sample text image is determined through the third network model, and a loss corresponding to the sample text image is determined based on the predicted text information and the annotated text information corresponding to the sample text image. The third network model is trained based on the losses corresponding to the sample text images, to obtain the text recognition model. The electronic device invokes the text recognition model to perform text recognition on the text image to obtain the first text information.

Operation A12. Determine at least one piece of second text information based on the first text information, where semantics of the second text information is the same as, opposite to, or similar to semantics of the first text information.

When the semantics of the second text information is the same as the semantics of the first text information, the first text information and the second text information express the same semantics. That the semantics of the second text information is the same as the semantics of the first text information means that a semantic similarity between the second text information and the first text information is greater than a first set threshold (for example, the first set threshold is 0.95). For example, the first text information is “the weather is really good today”, and the second text information is “the weather is clear and cloudless”. In this case, the semantics of the first text information is the same as the semantics of the second text information.

When the semantics of the second text information is opposite to the semantics of the first text information, the first text information and the second text information express opposite semantics. That the semantics of the second text information is opposite to the semantics of the first text information means that a semantic similarity between the second text information and the first text information is less than a second set threshold, and the second set threshold is less than the first set threshold. For example, the second set threshold is 0.05. For example, the first text information is “I just come back from the outside”, and the second text information is “I just need to go out for a walk”. In this case, the semantics of the first text information is opposite to the semantics of the second text information.

When the semantics of the second text information is similar to the semantics of the first text information, the first text information and the second text information express similar semantics. That the semantics of the second text information is similar to the semantics of the first text information means that a semantic similarity between the second text information and the first text information is greater than a third set threshold and less than a fourth set threshold. The third set threshold is greater than or equal to the second set threshold and less than or equal to the first set threshold. For example, the third set threshold is 0.8. The fourth set threshold is greater than the third set threshold and less than or equal to the first set threshold. For example, the fourth set threshold is 0.9. For example, the first text information is “I want to visit a scenic spot A”, and the second text information is “I want to travel to a scenic spot B”. In this case, the semantics of the first text information is similar to the semantics of the second text information.

Text expansion may be performed on the first text information in any text expansion manner to obtain at least one piece of second text information. For example, an application program having a text expansion function is installed on the electronic device, and text expansion is performed on the first text information through the text expansion function. Alternatively, a readily-available text expansion model may be directly obtained to perform text expansion on the first text information. Alternatively, a fourth network model may be trained by using a fourth sample set to obtain a text expansion model, and the electronic device invokes the text expansion model to perform text expansion on the first text information.

A structure, a size, and the like of the text expansion model are not limited in the embodiments of the present disclosure. In some embodiments, model structures of the text expansion model and the fourth network model are the same, and there is only a difference in model parameters. In an exemplary embodiment, pre-training may be performed on an initial network model to obtain a masked language model. The masked language model is used as the fourth network model, or the fourth network model is constructed based on the masked language model. The fourth network model is trained to obtain the text expansion model.

An initial sample set may be obtained, and the initial sample set includes a plurality of pieces of sample text information. For any piece of sample text information, masking may be performed on the sample text information, to mask at least one word in the sample text information, to obtain masked text information. The masked text information is inputted into the initial network model, and at least one piece of predicted text information is determined through the initial network model. The predicted text information is determined by predicting each masked word and based on the masked text information and each predicted word.

In some embodiments, for any masked word, at least one candidate word and an appearance probability of each candidate word may be obtained through the initial network model. A candidate word with an appearance probability greater than a set threshold is selected from the at least one candidate word, and the selected candidate word is used as a predicted word corresponding to the masked word. In this manner, the predicted word corresponding to each masked word may be determined, so that the at least one piece of predicted text information is determined based on the masked text information and each predicted word.

A loss of any piece of sample text information may be determined based on the sample text information and each piece of predicted text information corresponding to the sample text information. The initial network model is adjusted based on the losses of the plurality of pieces of sample text information, to obtain the masked language model. An operating principle of the masked language model is similar to an operating principle of the initial network model, and details are not described herein again. In some embodiments, the masked language model is a bidirectional encoder representations from transforms (BERT) model.

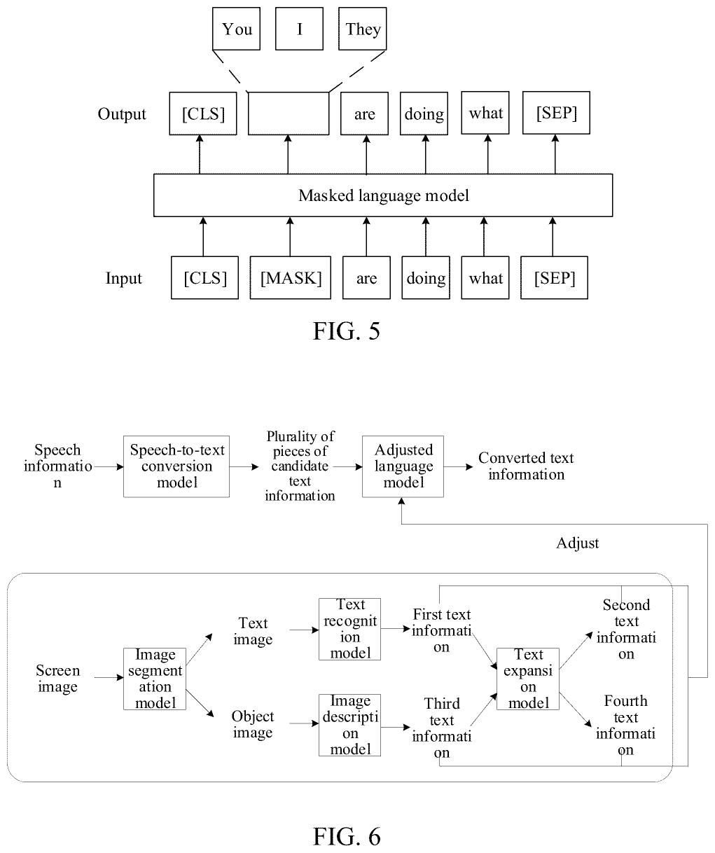

Referring to FIG. 5, which is a schematic diagram of a masked language model according to an embodiment of the present disclosure. Assuming that one piece of text information is “what are you doing”, masked text information “what are [MASK] doing” may be obtained by performing masking on the text information, where [MASK] represents a masked word.

The masked text information may be inputted into a masked language model, and an input format of the masked language model is “[CLS] what are [MASK] doing [SEP]”. [CLS] is a sentence start identifier, and the sentence start identifier represents a start of a sentence; and [SEP] is a sentence end identifier, and the sentence end identifier represents an end of a sentence. The masked language model may predict the masked word based on the masked text information to obtain a predicted word. At least one predicted word may be obtained for a masked word. For example, FIG. 5 shows that predicted words include “you”, “I”, and “they”. The masked language model may determine at least one piece of predicted text information based on the masked text information and the predicted word. For example, as shown in FIG. 5, the predicted text information includes “what are you doing”, “what am I doing”, and “what are they doing”.

In some embodiments, the masked language model may determine an appearance probability of each predicted word. For any piece of predicted text information, an appearance probability of the predicted text information is determined based on an appearance probability of each predicted word included in the predicted text information. As shown in FIG. 5, an appearance probability of the predicted word “you” is 85%. In this case, an appearance probability of the predicted text information “what are you doing” is 85%.

In the embodiments of the present disclosure, the masked language model may be used as the fourth network model, or the fourth network model is constructed based on the masked language model. The fourth network model is trained based on the fourth sample set to obtain the text expansion model. The fourth sample set includes a plurality of pieces of sample text information and annotated text information corresponding to each piece of sample text information. The annotated text information corresponding to the sample text information is obtained through annotation and is the same as, opposite to, or similar to semantics of the sample text information.

During training of the fourth network model, any piece of sample text information may be inputted into the fourth network model, and predicted text information corresponding to the sample text information is determined through the fourth network model. The predicted text information corresponding to the sample text information is obtained through prediction and is the same as or opposite to semantics of the sample text information. Based on the predicted text information and the annotated text information corresponding to the sample text information, a loss corresponding to the sample text information is determined. The fourth network model is trained based on the losses corresponding to the plurality of pieces of sample text information, to obtain the text expansion model. The electronic device invokes the text expansion model to perform text expansion on the first text information to obtain the second text information.

When text expansion is performed on the first text information, a specific word in the first text information may be replaced to obtain a replaced word. The word before replacement and the replaced word are synonyms or antonyms. For example, the word “wonderful” in the first text information may be replaced with a word such as “elegant” or “beautiful”. Alternatively, a specific word in the first text information may be replaced to obtain replaced text. The replaced text is obtained by making a sentence on the word before replacement. For example, the word “construct” in the first text information may be replaced with text such as “construct a wonderful home” or “construct a river-crossing bridge”. The second text information may be obtained based on the replaced word or the replaced text. In this case, the semantics of the second text information is the same as, opposite to, or similar to the semantics of the first text information.

Alternatively, when text expansion is performed on the first text information, the semantics of the first text information may be extracted, and sentence-making may be performed based on the semantics of the first text information, to obtain the second text information. In this case, the semantics of the second text information is the same as, opposite to, or similar to the semantics of the first text information.

Operation A13. Determine the first text information and the at least one piece of second text information as the screen text information. That is, the screen text information includes the first text information and the at least one piece of second text information.

In this way, through the foregoing manner, text recognition is performed on the text image to obtain the first text information in the text image, and a plurality of pieces of second text information are obtained through expansion based on the first text information. Both the first text information and the plurality of pieces of second text information are used as the screen text information. On one hand, using the first text information as the screen text information can ensure high accuracy and reliability of the screen text information. On the other hand, using the second text information obtained through expansion based on the first text information also as the screen text information can ensure the diversity of the screen text information.

Case A2. Determine the screen text information based on the object image. That is, the object image may be segmented from the screen image. In Case A2, the determining the screen text information based on the object image includes Operation A21 to Operation A23.

Operation A21. Perform image description processing on the object image to obtain third text information, where the third text information describes the object in the object image.

For example, if the object image is an image of a flowchart, the third text information describes the flowchart. For example, the third text information includes content of each operation in the flowchart. If the object image is an image of a living being, the third text information describes the living being. For example, the third text information includes an appearance (a color, a texture, and the like) of the living being, a type of the living being, an inhabiting environment of the living being, and the like. If the object image is an image of an application program interface, the third text information includes content on the interface, an interface type, an interface function, and the like.

image description processing may be performed on the object image in any image description manner, to obtain the third text information corresponding to the object image. For example, an application program having an image description processing function is installed on the electronic device, and image description processing is performed on the object image through the image description function. Alternatively, a readily-available image description model may be directly obtained, and image description processing is performed on the object image through the image description model. Alternatively, a fifth network model may be trained by using a fifth sample set to obtain an image description model, and the electronic device invokes the image description model to perform image description processing on the object image.

A structure, a size, and the like of the image description model are not limited in the embodiments of the present disclosure. When the fifth network model is trained by using the fifth sample set to obtain the image description model, model structures of the image description model and the fifth network model are the same, and there is only a difference in model parameters. The fifth sample set includes a plurality of sample object images and annotated text information corresponding to each sample object image. Any sample object image may be inputted into the fifth network model, predicted text information corresponding to the sample object image is determined through the fifth network model, and a loss corresponding to the sample object image is determined based on the predicted text information and the annotated text information corresponding to the sample object image. The fifth network model is trained based on the losses corresponding to the sample object images, to obtain the image description model. The electronic device invokes the image description model to perform image description processing on the object image to obtain the third text information.

Operation A22. Determine at least one piece of fourth text information based on the third text information, where semantics of the fourth text information is the same as, opposite to, or similar to semantics of the third text information.

When the semantics of the fourth text information is the same as the semantics of the third text information, the fourth text information and the third text information express the same semantics, where that the semantics of the fourth text information is the same as the semantics of the third text information means that a semantic similarity between the fourth text information and the third text information is greater than a first set threshold.

When the semantics of the fourth text information is opposite to the semantics of the third text information, the fourth text information and the third text information express opposite semantic. That the semantics of the fourth text information is opposite to the semantics of the third text information means that a semantic similarity between the fourth text information and the third text information is less than a second set threshold.

When the semantics of the fourth text information is similar to the semantics of the third text information, the fourth text information and the third text information express similar semantics. That the semantics of the fourth text information is similar to the semantics of the third text information means that a semantic similarity between the fourth text information and the third text information is greater than a third set threshold and less than a fourth set threshold. Text expansion may be performed on the third text information in any text expansion manner to obtain at least one piece of fourth text information. For example, an application program having a text expansion function is installed on the electronic device, and text expansion is performed on the third text information through the text expansion function. Alternatively, a readily-available text expansion model may be directly obtained, and text expansion is performed on the third text information. Alternatively, the fourth network model may be trained by using the fourth sample set to obtain a text expansion model, and the electronic device invokes the text expansion model to perform text expansion on the third text information. For an implementation of Operation A22, reference may be made to the description of Operation A12, and implementation principles of the two operations are similar. Details are not described herein again.

Operation A23. Determine the third text information and the at least one piece of fourth text information as the screen text information. That is, the screen text information includes the third text information and the at least one piece of fourth text information.

In this way, through the foregoing manner, image description processing is performed on the object image to obtain the third text information corresponding to the object image, and a plurality of pieces of fourth text information are obtained through expansion based on the third text information. Both the third text information and the plurality of pieces of fourth text information are used as the screen text information. On one hand, using the third text information as the screen text information can ensure high accuracy and reliability of the screen text information. On the other hand, using the fourth text information obtained through expansion based on the third text information also as the screen text information can ensure the diversity of the screen text information.

Case A3: Determine the screen text information based on the text image and the object image. That is, the text image and the object image may be segmented from the screen image. In Case A3, the determining the screen text information based on the text image and the object image includes Operation A31 to Operation A33.

Operation A31. Perform text recognition on the text image to obtain first text information in the text image; and perform image description processing on the object image to obtain third text information. For an implementation of Operation A31, reference may be made to the description of Operation A11 and Operation A21. Details are not described herein again.

Operation A32. Determine at least one piece of second text information based on the first text information; and determine at least one piece of fourth text information based on the third text information. For an implementation of Operation A32, reference may be made to the description of Operation A12 and Operation A22. Details are not described herein again.

Operation A33. Determine the first text information, the at least one piece of second text information, the third text information, and the at least one piece of fourth text information as the screen text information. That is, the screen text information includes the first text information, the at least one piece of second text information, the third text information, and the at least one piece of fourth text information.

In one embodiment, “determining the target appearance indicator of each piece of candidate text information based on the screen text information” in Operation 203 includes Operation 2033 to Operation 2035.

Operation 2033. Perform word segmentation on each piece of candidate text information to obtain words included in the candidate text information.

Word segmentation may be performed on the candidate text information in any word segmentation manner to obtain the words included in the candidate text information. For example, an application program having a word segmentation function is installed on the electronic device, and the candidate text information is divided into a plurality of words through the word segmentation function. Alternatively, the electronic device may invoke a dictionary to divide the candidate text information into a plurality of words based on words included in the dictionary.

For example, one piece of candidate text information is “the weather is really good today”. By performing word segmentation on the candidate text information, three words including “the weather”, “is really good”, and “today” may be obtained.

Operation 2034. Determine a target appearance indicator of each word included in the candidate text information based on the screen text information, where the target appearance indicator of the word represents a probability that the word is included in the speech information.

In the embodiments of the present disclosure, the target appearance indicator of any word is greater than or equal to 0. A larger target appearance indicator of a word indicates a higher probability that the word is actually included in the speech information, that is, a higher probability that the word appears in the information sharing scenario. In some embodiments, the target appearance indicator of the word is a probability value, and may represent a probability that the word appears in the information sharing scenario.

In an exemplary embodiment, a target appearance indicator of a first word is a probability that the word appears in the information sharing scenario, a target appearance indicator of a second word is a probability that the second word appears in the information sharing scenario under a condition that the first word appears, and a target appearance indicator of a third word is a probability that the third word appears in the information sharing scenario under a condition that the first word and the second word appear. The rest can be deduced by analogy. That is, the target appearance indicator of any word is a probability that the word appears in the information sharing scenario under a condition that each word located before the word appears. In this case, assuming that the candidate text information includes t connected words, where t=[1, 2, . . . , m], and m is a positive integer. A target appearance indicator of a with word may be expressed as: P(wᵢ|w₁, w₂, . . . , wᵢ₋₁).

In another embodiment, a target appearance indicator of a word is related to an at most set quantity of words located before the word. In other words, the target appearance indicator of any word is a probability that the word appears in the information sharing scenario under a condition that a maximum set quantity of words located before the word appear. In this case, assuming that the candidate text information includes t connected words, where t=[1, 2, . . . , m], and m is a positive integer. A target appearance indicator of a with word may be expressed as: P(wᵢ|wᵢ₋ₙ₊₁, wᵢ₋ₙ₊₂, . . . , wᵢ₋₁), where n is the at most set quantity.

In some embodiments, Operation 2034 includes Operation 20341 to Operation 20342.

Operation 20341. Obtain an initial appearance indicator of each word, where the initial appearance indicator of the word represents a probability that the word appears in a general scenario.

In the embodiments of the present disclosure, the initial appearance indicator of any word is greater than or equal to 0. A larger initial appearance indicator of a word indicates a higher probability that the word appears in the general scenario, and correspondingly, a higher probability that the word appears in the information sharing scenario. In some embodiments, the initial appearance indicator of the word is a probability value, and represents a probability that the word appears in the information sharing scenario.

A general text set may be obtained. The general text set includes a plurality of pieces of general text information, and any piece of general text information is text appearing in the general scenario. By performing word segmentation on the plurality of pieces of general text information, a plurality of general words may be obtained, and a probability that each general word appears in the general scenario may be counted. For each word included in the candidate text information, a probability that a general word same as the word appears in the general scenario is determined as an initial appearance indicator of the word. If there is no general word same as the word, the initial appearance indicator of the word is 0, that is, the probability that the word appears in the general scenario is 0.

In one embodiment, the initial appearance indicator of any word included in the candidate text information is a probability that the word appears in the general scenario under a condition that each word located before the word appears. In another embodiment, the initial appearance indicator of any word included in the candidate text information is a probability that the word appears in the general scenario under a condition that a maximum set quantity of words located before the word appear.

Operation 20342. Adjust the initial appearance indicator of the word based on the screen text information to obtain the target appearance indicator of the word.

Because the screen text information is text information related to the information sharing scenario, a probability that any word appears in the general scenario may be adjusted based on the screen text information to obtain a probability that the word appears in the information sharing scenario. It has been mentioned above that, in Case A1 to Case A3, the screen text information includes different content. The following describes implementations of Operation 20342 for Case A1 to Case A3 respectively.

For Case A1, the screen text information includes first text information and at least one piece of second text information. In this case, Operation 20342 includes: determining a first appearance indicator of the word based on the first text information and the at least one piece of second text information, where the first appearance indicator of the word represents a probability that the word appears in the first text information and the at least one piece of second text information; and performing weighted calculation on the first appearance indicator of the word and the initial appearance indicator of the word to obtain the target appearance indicator of the word.

The first appearance indicator of the word is greater than or equal to 0. A larger first appearance indicator of a word indicates a higher probability that the word appears in the first text information and the at least one piece of second text information. In some embodiments, the first appearance indicator of the word is a probability value, and represents a probability that the word appears in the first text information and the at least one piece of second text information.

In this embodiment of the present disclosure, the first text information includes a plurality of first words, and the second text information includes a plurality of second words. The first words and the second words may be collectively referred to as text words. Word segmentation may be performed on the first text information, and word segmentation may be performed on the at least one piece of second text information to obtain a plurality of text words. In addition, a probability that each text word appears in the first text information and the at least one piece of second text information is counted.

For each word included in the candidate text information, a probability that a text word same as the word appears in the first text information and the at least one piece of second text information is determined as the first appearance indicator of the word.

In some embodiments, the first appearance indicator of each word included in the candidate text information is a probability that the word appears in the first text information and the at least one piece of second text information under a condition that each word located before the word appears. In another embodiment, the first appearance indicator of each word included in the candidate text information is a probability that the word appears in the first text information and the at least one piece of second text information under a condition that a maximum set quantity of words located before the word appear.

A weight of the first appearance indicator of each word and a weight of the initial appearance indicator of the word included in the candidate text information are obtained. Weighted summation is performed based on the first appearance indicator of the word and the weight thereof and the initial appearance indicator of the word and the weight thereof, to obtain the target appearance indicator of the word. The first appearance indicator of the word is the probability that the word appears in the first text information and the at least one piece of second text information, and the first text information and the at least one piece of second text information are related to the information sharing scenario; and the initial appearance indicator of the word is the probability that the word appears in the general scenario, so that the target appearance indicator based on the word may represent the probability that the word appears in the information sharing scenario.

For example, if an initial appearance indicator of a word included in the candidate text information is p, and a first appearance indicator of the word is q, a target appearance indicator of the word may be expressed as: (1−a)*p+aq, where 1−a represents a weight of the initial appearance indicator of the word, and a represents a weight of the first appearance indicator of the word. a belongs to [0, 1], that is, a is greater than or equal to 0 and less than or equal to 1. A larger value of a indicates a smaller proportion of the word appearing in the general scenario and a larger proportion of the word appearing in the first text information and the at least one piece of second text information.

In this way, through the foregoing manner, the appearance probability of the word in the candidate text information in the first text information and the at least one piece of second text information and the appearance probability of the word in the general scenario are comprehensively considered, so that the appearance probability of the word in the speech information is determined, that is, the target appearance indicator configured for reflecting the probability that the word appears in the information sharing scenario is determined, which can ensure that the determined target appearance indicator can more accurately reflect the probability that the word appears in the information sharing scenario.

In Case A2, the screen text information includes third text information and at least one piece of fourth text information. In this case, Operation 20342 includes: determining a second appearance indicator of the word based on the third text information and the at least one piece of fourth text information, where the second appearance indicator of the word represents a probability that the word appears in the third text information and the at least one piece of fourth text information; and performing weighted calculation on the second appearance indicator of the word and the initial appearance indicator of the word to obtain the target appearance indicator of the word.

In this embodiment of the present disclosure, the second appearance indicator of any word included in the candidate text information is greater than or equal to 0. A larger second appearance indicator of a word indicates a higher probability that the word appears in the third text information and the at least one piece of fourth text information. In some embodiments, the second appearance indicator of the word is a probability value, and represents a probability that the word appears in the third text information and the at least one piece of fourth text information.

In this embodiment of the present disclosure, the third text information includes a plurality of third words, and the fourth text information includes a plurality of fourth words. The third words and the fourth words may be collectively referred to as image words. Word segmentation may be performed on the third text information, and word segmentation may be performed on the at least one piece of fourth text information to obtain a plurality of image words. In addition, a probability that each image word appears in the third text information and the at least one piece of fourth text information is counted.

For each word included in the candidate text information, a probability that an image word same as the word appears in the third text information and the at least one piece of fourth text information is determined as the second appearance indicator of the word.

In some embodiments, the second appearance indicator of each word included in the candidate text information is a probability that the word appears in the third text information and the at least one piece of fourth text information under a condition that each word located before the word appears. In another embodiment, the second appearance indicator of each word included in the candidate text information is a probability that the word appears in the third text information and the at least one piece of fourth text information under a condition that a maximum set quantity of words located before the word appear.

A weight of the second appearance indicator of each word and a weight of the initial appearance indicator of the word included in the candidate text information are obtained. Weighted summation is performed based on the second appearance indicator of the word and the weight thereof and the initial appearance indicator of the word and the weight thereof, to obtain the target appearance indicator of the word. The second appearance indicator of the word is the probability that the word appears in the third text information and the at least one piece of fourth text information, and the third text information and the at least one piece of fourth text information are related to the information sharing scenario; and the initial appearance indicator of the word is the probability that the word appears in the general scenario, so that the target appearance indicator based on the word may represent the probability that the word appears in the information sharing scenario.

In this way, through the foregoing manner, the appearance probability of the word in the candidate text information in the third text information and the at least one piece of fourth text information and the appearance probability of the word in the general scenario are comprehensively considered, so that the appearance probability of the word in the speech information is determined, that is, the target appearance indicator configured for reflecting the probability that the word appears in the information sharing scenario is determined, which can ensure that the determined target appearance indicator can more accurately reflect the probability that the word appears in the information sharing scenario.

In Case A3, the screen text information includes first text information, at least one piece of second text information, third text information, and at least one piece of fourth text information. In this case, Operation 20342 includes: determining a third appearance indicator of the word based on the first text information, the at least one piece of second text information, the third text information, and the at least one piece of fourth text information, where the third appearance indicator of the word represents a probability that the word appears in the first text information, the at least one piece of second text information, the third text information, and the at least one piece of fourth text information; and performing weighted calculation on the third appearance indicator of the word and the initial appearance indicator of the word to obtain the target appearance indicator of the word.

The third appearance indicator of the word is greater than or equal to 0. A larger third appearance indicator of a word indicates a higher probability that the word appears in the first text information, the at least one piece of second text information, the third text information, and the at least one piece of fourth text information. In some embodiments, the third appearance indicator of the word is a probability value, and represents a probability that the word appears in the first text information, the at least one piece of second text information, the third text information, and the at least one piece of fourth text information.

In this embodiment of the present disclosure, the first text information includes a plurality of first words, the second text information includes a plurality of second words, the third text information includes a plurality of third words, and the fourth text information includes a plurality of fourth words. The first words, the second words, the third words, and the fourth words may be collectively referred to as screen words. Word segmentation may be performed on the first text information, word segmentation may be performed on the at least one piece of second text information, word segmentation may be performed on the third text information, and word segmentation may be performed on the at least one piece of fourth text information, to obtain a plurality of screen words. In addition, a probability that each screen word appears in the first text information, the at least one piece of second text information, the third text information, and the at least one piece of fourth text information is counted.

For each word included in the candidate text information, a probability that a screen word same as the word appears in the first text information, the at least one piece of second text information, the third text information, and the at least one piece of fourth text information is determined as the third appearance indicator of the word.

In some embodiments, the third appearance indicator of each word included in the candidate text information is a probability that the word appears in the first text information, the at least one piece of second text information, the third text information, and the at least one piece of fourth text information under a condition that each word located before the word appears. In another embodiment, the third appearance indicator of each word included in the candidate text information is a probability that the word appears in the first text information, the at least one piece of second text information, the third text information, and the at least one piece of fourth text information under a condition that a maximum set quantity of words located before the word appear.

A weight of the third appearance indicator of each word and a weight of the initial appearance indicator of the word included in the candidate text information are obtained. Weighted summation is performed based on the third appearance indicator of the word and the weight thereof and the initial appearance indicator of the word and the weight thereof, to obtain the target appearance indicator of the word. The third appearance indicator of the word is the probability that the word appears in the first text information, the at least one piece of second text information, the third text information, and the at least one piece of fourth text information, and the first text information, the at least one piece of second text information, the third text information, and the at least one piece of fourth text information are related to the information sharing scenario; and the initial appearance indicator of the word is the probability that the word appears in the general scenario, so that the target appearance indicator based on the word may represent the probability that the word appears in the information sharing scenario.

In this way, through the foregoing manner, the appearance probability of the word in the candidate text information in the first text information, the at least one piece of second text information, the third text information, and the at least one piece of fourth text information and the appearance probability of the word in the general scenario are comprehensively considered, so that the appearance probability of the word in the speech information is determined, that is, the target appearance indicator configured for reflecting the probability that the word appears in the information sharing scenario is determined, which can ensure that the determined target appearance indicator can more accurately reflect the probability that the word appears in the information sharing scenario.

The initial appearance indicator of any word is a probability that the word appears in the general scenario, and the scenario in the embodiments of the present disclosure is an information sharing scenario. The information sharing scenario is a scenario for a specific field. For example, the specific field is a legal field or a medical field. For a word related to the specific field, a probability that the word appears in the general scenario is lower than a probability that the word appears in the specific field. For example, a word “sore throat” is related to the medical field, and a probability that “sore throat” appears in the general scenario is lower than a probability that “sore throat” appears in the medical field.

In the embodiments of the present disclosure, because the screen text information can reflect an information sharing scenario for a specific field, by adjusting a probability that a word appears in the general scenario based on a probability that the word appears in the screen text information, a probability that the word appears in the information sharing scenario for the specific field may be obtained through adjustment, that is, a target appearance indicator of the word is obtained, so that the accuracy of the target appearance indicator of the word is high.

Operation 2035. Determine the target appearance indicator of the candidate text information based on the target appearance indicators of the words included in the candidate text information.

Based on the probability that each word in the candidate text information appears in the information sharing scenario, the probability that the candidate text information appears in the information sharing scenario may be determined.

In some embodiments, Operation 2035 includes Operation B1 to Operation B3.

Operation B1. Obtain a first appearance indicator of the candidate text information, where the first appearance indicator of the candidate text information represents a probability that the speech information is converted into the candidate text information.

When the speech information is converted into a plurality of pieces of candidate text information by using a speech-to-text conversion function or invoking a speech-to-text conversion model, respective first appearance indicators of the plurality of pieces of candidate text information may be obtained at the same time. The first appearance indicator of the candidate text information is greater than or equal to 0. A larger first appearance indicator of candidate text information indicates a higher probability that the speech information is converted into the candidate text information. In some embodiments, the first appearance indicator of the candidate text information is a probability value, and represents a probability that the speech information is converted into the candidate text information.

Operation B2. Determine a second appearance indicator of the candidate text information based on the target appearance indicators of the words included in the candidate text information, where the second appearance indicator of the candidate text information represents a probability that the candidate text information is determined based on the words.

Calculation such as addition or multiplication may be performed on target appearance indicators of words in any piece of candidate text information to obtain the second appearance indicator of the candidate text information. The second appearance indicator of the candidate text information is greater than or equal to 0. A larger second appearance indicator of candidate text information indicates a higher probability that the candidate text information is determined based on the words. In some embodiments, the second appearance indicator of the candidate text information is a probability value, and represents a probability that the candidate text information is determined based on the words.

In some embodiments, the target appearance indicator of any word is a probability that the word appears in the information sharing scenario under a condition that each word located before the word appears. In this case, the second appearance indicator of the candidate text information may be expressed as: P(W)=P(w₁, w₂, . . . , Wₘ)=πP(wᵢ|w₁, w₂, . . . , wᵢ₋₁). P(W) represents the second appearance indicator of the candidate text information, and W represents the candidate text information, where the candidate text information includes m words, which are respectively: w₁, w₂, . . . , Wₘ. π represents a symbol of a continued multiplication function, and P(wᵢ|w₁, w₂, . . . , wᵢ₋₁) represents a target appearance indicator of a with word under a condition that a w₁^{th} word to a Wᵢ₋₁^{th} word appear.

Alternatively, the target appearance indicator of any word is a probability that the word appears in the information sharing scenario under a condition that a maximum set quantity of words located before the word appear. In this case, the second appearance indicator of the candidate text information may be expressed as: P(W)=P(w₁, w₂, . . . , Wₘ)=π₁^{m}P(wᵢ|wᵢ₋ₙ₊₁, wᵢ₋ₙ₊₂, . . . , wᵢ₋₁)·P(wᵢ|wᵢ₋ₙ₊₁, wᵢ₋ₙ₊₂, . . . , wᵢ₋₁) represents a target appearance indicator of a wᵢ^{th} word under a condition that a wᵢ₋ₙ₊₁^{th} word to a Wᵢ₋₁^{th} word appear.

$$P ( {w}_{i} \vert {w}_{i - n + 1} , {w}_{i - n + 2} , … , {w}_{i - 1} ) = \frac{count ( {w}_{i - n + 1} , {w}_{i - n + 2} , … , {w}_{i} )}{count ( {w}_{i - n + 1} , {w}_{i - n + 2} , … , {w}_{i - 1} )} .$$

count (wᵢ₋ₙ₊₁, wᵢ₋ₙ₊₂) . . . , wᵢ) represents a quantity of times of the wᵢ₋ₙ₊₁^{th} word to the wᵢ^{th} word appearing in each general text information, the first text information, the at least one piece of second text information, the third text information, and the at least one piece of fourth text information, and count (wᵢ₋ₙ₊₁, wᵢ₋ₙ₊₂, . . . , wᵢ₋₁) represents a quantity of times of the wᵢ₋ₙ₊₁^{th} word to the Wᵢ₋₁^{th} word appearing in each general text information, the first text information, the at least one piece of second text information, the third text information, and the at least one piece of fourth text information.

Operation B3. Perform weighted processing on the first appearance indicator of the candidate text information and the second appearance indicator of the candidate text information to obtain the target appearance indicator of the candidate text information.

A weight of the first appearance indicator of the candidate text information and a weight of the second appearance indicator of the candidate text information may be obtained. The weight of the first appearance indicator of the candidate text information may be greater than, equal to, or less than the weight of the second appearance indicator of the candidate text information. For example, the weight of the first appearance indicator of the candidate text information is 0.3, and the weight of the second appearance indicator of the candidate text information is 0.7.

Weighted processing is performed based on the first appearance indicator of the candidate text information and the weight thereof and the second appearance indicator of the candidate text information and the weight thereof, to obtain the target appearance indicator of the candidate text information.

In Operation 203, the screen image is segmented into the text image and the object image, to obtain the multimodal information in the screen image. Text recognition is performed on the text image to obtain the first text information, and text expansion is performed on the first text information to obtain the at least one piece of second text information. In this way, content of the text image is enriched, and more text related to the information sharing scenario is obtained. Similarly, image description processing is performed on the object image to obtain the third text information, and text expansion is performed on the third text information to obtain the at least one piece of fourth text information. In this way, content of the object image is enriched, and more text related to the information sharing scenario is obtained. Based on the foregoing rich text related to the information sharing scenario, a probability that each piece of candidate text information obtained by performing speech-to-text conversion on the speech information appears in the information sharing scenario is accurately determined, that is, the target appearance indicator is determined, so that the accuracy of the determined target appearance indicator can be improved.

Operation 204. Select the candidate text information whose target appearance indicator meets a requirement from the plurality of pieces of candidate text information as converted text information of the speech information.

The requirement met by the target appearance indicator is not limited in the embodiments of the present disclosure. For example, the requirement met by the target appearance indicator may be that the target appearance indicator is the largest, or the requirement met by the target appearance indicator may be that the target appearance indicator is greater than a set indicator threshold.

An example in which the requirement met by the target appearance indicator is the largest target appearance indicator is used. When the target appearance indicator of each piece of candidate text information is determined, candidate text information with the largest target appearance indicator may be selected as the converted text information of the speech information. The converted text information may be transmitted to a client of the speaker (that is, the terminal device 1 in FIG. 3) or may be transmitted to a client of the audience (that is, the terminal device 2 in FIG. 3), so that the terminal device displays the converted text information on a screen.

In one embodiment, a sixth network model may be trained by using a sixth sample set to obtain a language model. The language model may be an N-Gram language model. The sixth sample set includes a plurality of pieces of sample text information, an annotation probability that each piece of sample text information appears in the general scenario, and an annotation probability that each word in each piece of sample text information appears in the general scenario. The sample text information is text applicable to the general scenario.

The plurality of pieces of sample text information may be inputted into the sixth network model. The sixth network model may determine, for each piece of sample text information, a predicted probability that each word in the sample text information appears in the general scenario, and determine, based on the predicted probability that each word appears in the general scenario, a predicted probability that the sample text information appears in the general scenario. A loss of the sample text information is determined based on the predicted probability and the annotated probability that each word appears in the general scenario and the predicted probability and the annotated probability that each piece of sample text information appears in the general scenario. The sixth network model is adjusted based on the losses of the plurality of pieces of sample text information, to obtain a language model applicable to the general scenario.

Through the foregoing training manner, the language model can learn the probability that each word appears in the general scenario. In other words, the language model can learn an initial appearance indicator of each word in the candidate text information.

Since the language model is applicable to the general scenario, there is a difference between a probability that a word appears in the general scenario and a probability that the word appears in the information sharing scenario. Therefore, in the embodiments of the present disclosure, at least one of the first text information, the at least one piece of second text information, the third text information, and the at least one piece of fourth text information may be determined based on the screen image, and the language model is adjusted by using the text information, to obtain an adjusted language model.

The screen text information includes at least one of the first text information, the at least one piece of second text information, the third text information, and the at least one piece of fourth text information. A probability that each word in each piece of candidate text information appears in the screen text information may be determined based on the screen text information (the probability corresponds to the first appearance indicator, the second appearance indicator, or the third appearance indicator mentioned above). A parameter of the language model is adjusted based on the probability that each word in each piece of candidate text information appears in the screen text information, to obtain the adjusted language model, and the adjusted language model learns a probability that each word appears in the information sharing scenario. Therefore, a process of adjusting the parameter of the language model may be understood as: adjusting the probability that each word appears in the general scenario based on the probability that each word in each piece of candidate text information appears in the screen text information, to obtain the probability that each word appears in the information sharing scenario.

Next, each piece of candidate text information is inputted into the adjusted language model, and by invoking the adjusted language model, a probability that each piece of candidate text information appears in the information sharing scenario can be obtained, so that the converted text information whose target appearance indicator meets the requirement can be selected from the plurality of pieces of candidate text information. In other words, the foregoing Operation 203 or the foregoing Operation 203 and Operation 204 may be implemented based on the adjusted language model.

Since the sample text information included in the sixth sample set is text applicable to the general scenario, the language model obtained through training based on the sixth sample set is applicable to the general scenario, and the information sharing scenario in the embodiments of the present disclosure is generally a scenario for a specific field (such as the medical field or the legal field). Because there may be a difference between the information sharing scenario and the general scenario, a probability that a word, text, or the like related to the information sharing scenario appears in the information sharing scenario is greater than or equal to a probability that the word, the text, or the like appears in the general scenario. Based on this, in the embodiments of the present disclosure, the screen text information is determined based on the screen image, and the language model is adjusted by using the screen text information, to obtain the adjusted language model.

Because the screen image and the screen text information are related to the information sharing scenario, a more accurate target appearance indicator of the text related to the information sharing scenario and a more accurate target appearance indicator of each word included in the text may be determined by using the adjusted language model than determining a target appearance indicator of the text related to the information sharing scenario and a target appearance indicator of each word included in the text by using the original language model. In other words, the adjusted language model processes the word or the text related to the information sharing scenario, and the determined probability that the word or the text appears in the information sharing scenario is greater, so that the adjusted language model has a more accurate capability to score the word or the text in the information sharing scenario.

For example, in the information sharing scenario, the speaker speaks speech information of “the two parties signing the contract have reached an agreement through the principle of voluntariness, mutual benefit, and unanimity through consultation”, and text of “contract-related laws” is displayed on the screen. When speech-to-text conversion is performed on the speech information, two pieces of candidate text information are obtained: “the two parties signing the contract have reached an agreement through the principle of voluntary, mutual benefit, and unanimity through consulate” and “the two parties signing the contract have reached an agreement through the principle of voluntariness, mutual benefit, and unanimity through consultation”.

Generally, probabilities of “voluntary” and “consulate” appearing in the general scenario are higher than probabilities of “voluntary” and “consulate” appearing in the legal field, and probabilities of “voluntariness” and “consultation” appearing in the general scenario are lower than probabilities of “voluntariness” and “consultation” appearing in the legal field. Therefore, appearance probabilities of “voluntary” and “consulate” determined through the language model are higher than appearance probabilities of “voluntariness” and “consultation” determined through the language model, leading to the candidate text information “the two parties signing the contract have reached an agreement through the principle of voluntary, mutual benefit, and unanimity through consulate” having a higher appearance probability than the candidate text information “the two parties signing the contract have reached an agreement through the principle of voluntariness, mutual benefit, and unanimity through consultation”. As a result, “the two parties signing the contract have reached an agreement through the principle of voluntary, mutual benefit, and unanimity through consulate” is determined as the converted text information of the speech information, leading to wrong converted text information.

Because “contract-related laws” is displayed on the screen, the screen text information determined on the screen image includes “contract-related laws”, and it may be determined through “contract-related laws” that the information sharing scenario is a scenario related to the legal field. Since the probabilities of “voluntary” and “consulate” appearing in the general scenario are higher than the probabilities of “voluntary” and “consulate” appearing in the legal field, and the probabilities of “voluntariness” and “consultation” appearing the general scenario are lower than the probabilities of “voluntariness” and “consultation” appearing in the legal field, appearance probabilities of “voluntary” and “consulate” determined through the adjusted language model are lower than appearance probabilities of “voluntariness” and “consultation” determined through the adjusted language model, so that the candidate text information “the two parties signing the contract have reached an agreement through the principle of voluntariness, mutual benefit, and unanimity through consultation” has a higher appearance probability than the candidate text information “the two parties signing the contract have reached an agreement through the principle of voluntary, mutual benefit, and unanimity through consulate”, which helps determine “the two parties signing the contract have reached an agreement through the principle of voluntariness, mutual benefit, and unanimity through consultation” as the converted text information of the speech information, thereby improving the accuracy of the converted text information.

Through the adjusted language model, an appearance probability of a determined word or text related to the information sharing scenario can be improved, which helps correct incorrect text obtained by converting the speech information, thereby improving the accuracy of the converted text information.

Information (including but not limited to user device information, user personal information, or the like), data (including but not limited to data configured for analysis, stored data, presented data, or the like), and signals involved in the present disclosure are all authorized by a user or fully authorized by various parties, and collection, use, and processing of related data need to comply with relevant laws, regulations, and standards of relevant regions. For example, the screen image, the speech information, and the like involved in the present disclosure are all obtained in a fully authorized case

In the foregoing method, the screen image is an image related to the speech information and displayed on a screen during generation of the speech information in the information sharing scenario. Therefore, the screen image and the speech information are highly correlated, and the screen image and the speech information both reflect a characteristic of the information sharing scenario. The target appearance indicators of the plurality of pieces of candidate text information obtained after speech-to-text conversion is performed on the speech information are determined based on the screen image. The target appearance indicator of the candidate text information represents a probability that the candidate text information actually corresponds to the speech information, so that the target appearance indicator of the candidate text information is related to the information sharing scenario, thereby improving the accuracy of the target appearance indicator of the candidate text information. Therefore, the converted text information of the speech information determined based on the target appearance indicators of the plurality of pieces of candidate text information has high accuracy.

The speech-to-text conversion method of the embodiments of the present disclosure is described above from the perspective of method operations. The following systematically and comprehensively describes the speech-to-text conversion method. Referring to FIG. 6, which is a schematic diagram of a speech-to-text conversion method according to an embodiment of the present disclosure. This embodiment of the present disclosure is implemented based on the information sharing scenario shown in FIG. 3. The information sharing scenario may be a conference scenario, a teaching scenario, or the like.

In this embodiment of the present disclosure, on one hand, speech information of a speech of a speaker is obtained, and the speech information is inputted into a speech-to-text conversion model, to obtain a plurality of pieces of candidate text information. On the other hand, an image displayed on a screen during generation of the speech information is obtained, to obtain a screen image, and a language model is adjusted based on the screen image, to obtain an adjusted language model. Converted text information of the speech information is determined from the plurality of pieces of candidate text information by invoking the adjusted language model.

When the language model is adjusted based on the screen image, an image segmentation model is first invoked to segment the screen image, to obtain a text image and an object image. Further, a text recognition model is invoked to perform text recognition on the text image to obtain first text information, and a text expansion model is invoked to perform text expansion on the first text information to obtain second text information. An image description model is invoked to perform image description processing on the object image to obtain third text information, and the text expansion model is invoked to perform text expansion on the third text information to obtain fourth text information. Further, the language model is adjusted based on the first text information, the second text information, the third text information, and the fourth text information. A specific implementation of adjusting the language model has been described above. Details are not described herein again.

The image segmentation model, the text recognition model, the image description model, the text expansion model, the speech-to-text conversion model, and the language model are all correspondingly described above. Details are not described herein again.

In this embodiment of the present disclosure, the screen image and the speech information are highly correlated, and the screen image and the speech information both reflect a characteristic of the information sharing scenario. The language model is adjusted based on the screen image, so that the adjusted language model is applicable to the information sharing scenario. By invoking the adjusted language model, the converted text information corresponding to the speech information can be accurately determined from the plurality of pieces of candidate text information obtained by performing speech-to-text conversion on the speech information, thereby improving the accuracy of the converted text information.

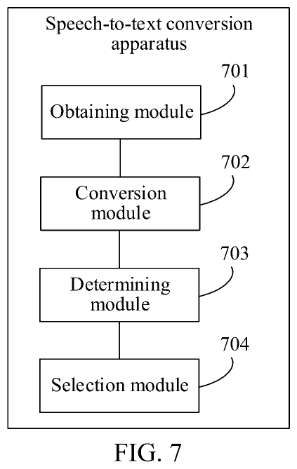

FIG. 7 is a schematic structural diagram of a speech-to-text conversion apparatus according to an embodiment of the present disclosure. As shown in FIG. 7, the apparatus includes:
an obtaining module 701, configured to obtain to-be-converted speech information and a screen image, the screen image being an image related to the speech information and displayed on a screen during generation of the speech information;
a conversion module 702, configured to perform speech-to-text conversion on the speech information to obtain a plurality of pieces of candidate text information;
a determining module 703, configured to determine target appearance indicators corresponding to the plurality of pieces of candidate text information based on the screen image, a target appearance indicator of one piece of the candidate text information representing a probability that the one piece of candidate text information corresponds to the speech information; and
a selection module 704, configured to select the candidate text information whose target appearance indicator meets a requirement from the plurality of pieces of candidate text information as converted text information of the speech information.
in one embodiment, the conversion module 702 is configured to: perform segmentation on the speech information to obtain a plurality of speech segments; perform speech-to-text conversion on each speech segment to obtain a character corresponding to the speech segment; and determining the plurality of pieces of candidate text information based on the characters corresponding to the plurality of speech segments.

In one embodiment, the determining module 703 is configured to: determine screen text information based on the screen image; and determine the target appearance indicators corresponding to the plurality of pieces of candidate text information based on the screen text information.

In one embodiment, the determining module 703 is configured to: perform image segmentation on the screen image to obtain at least one of a text image and an object image, where the text image reflects text displayed on the screen, and the object image reflects an object displayed on the screen; and determine the screen text information based on at least one of the text image and the object image.

In one embodiment, the determining module 703 is configured to: perform text recognition on the text image to obtain first text information in the text image; determine at least one piece of second text information based on the first text information, where semantics of the second text information is the same as, opposite to, or similar to semantics of the first text information; and determine the first text information and the at least one piece of second text information as the screen text information.

In one embodiment, the determining module 703 is configured to: perform image description processing on the object image to obtain third text information, where the third text information describes the object in the object image; determine at least one piece of fourth text information based on the third text information, where semantics of the fourth text information is the same as, opposite to, or similar to semantics of the third text information; and determine the third text information and the at least one piece of fourth text information as the screen text information.

In one embodiment, the determining module 703 is configured to: perform word segmentation on each piece of candidate text information to obtain words included in the candidate text information; determine a target appearance indicator of each word included in the candidate text information based on the screen text information, where the target appearance indicator of the word represents a probability that the word is included in the speech information; and determine the target appearance indicator of the candidate text information based on the target appearance indicators of the words included in the candidate text information.

In one embodiment, the determining module 703 is configured to: obtain an initial appearance indicator of each word, where the initial appearance indicator of the word represents a probability that the word appears in a general scenario; and adjust the initial appearance indicator of the word based on the screen text information to obtain the target appearance indicator of the word.

In one embodiment, the screen text information includes the first text information and the at least one piece of second text information; and
the determining module 703 is configured to: determine a first appearance indicator of the word based on the first text information and the at least one piece of second text information, where the first appearance indicator of the word represents a probability that the word appears in the first text information and the at least one piece of second text information; and perform weighted calculation on the first appearance indicator of the word and the initial appearance indicator of the word to obtain the target appearance indicator of the word.

In one embodiment, the screen text information includes the third text information and the at least one piece of fourth text information; and
the determining module 703 is configured to: determine a second appearance indicator of the word based on the third text information and the at least one piece of fourth text information, where the second appearance indicator of the word represents a probability that the word appears in the third text information and the at least one piece of fourth text information; and perform weighted calculation on the second appearance indicator of the word and the initial appearance indicator of the word to obtain the target appearance indicator of the word.

In one embodiment, the screen text information includes the first text information, the at least one piece of second text information, the third text information, and the at least one piece of fourth text information; and
the determining module 703 is configured to: determine a third appearance indicator of the word based on the first text information, the at least one piece of second text information, the third text information, and the at least one piece of fourth text information, where the third appearance indicator of the word represents a probability that the word appears in the first text information, the at least one piece of second text information, the third text information, and the at least one piece of fourth text information; and perform weighted calculation on the third appearance indicator of the word and the initial appearance indicator of the word to obtain the target appearance indicator of the word.

In one embodiment, the determining module 703 is configured to: obtain a first appearance indicator of the candidate text information, where the first appearance indicator of the candidate text information represents a probability that the speech information is converted into the candidate text information; determine a second appearance indicator of the candidate text information based on the target appearance indicators of the words, where the second appearance indicator of the candidate text information represents a probability that the candidate text information is determined based on the words; and perform weighted processing on the first appearance indicator of the candidate text information and the second appearance indicator of the candidate text information to obtain the target appearance indicator of the candidate text information.

In the foregoing apparatus, the screen image is an image related to the speech information and displayed on a screen during generation of the speech information in the information sharing scenario. Therefore, the screen image and the speech information are highly correlated, and the screen image and the speech information both reflect a characteristic of the information sharing scenario. The target appearance indicators of the plurality of pieces of candidate text information obtained after speech-to-text conversion is performed on the speech information are determined on the screen image. The target appearance indicator of the candidate text information represents a probability that the candidate text information corresponds to the speech information, so that the target appearance indicator of the candidate text information is related to the information sharing scenario, thereby improving the accuracy of the target appearance indicator of the candidate text information. Therefore, the converted text information of the speech information determined based on the target appearance indicators of the plurality of pieces of candidate text information has high accuracy.

When the apparatus provided in FIG. 7 implements the functions of the apparatus, only division of the foregoing functional modules is used as an example for description. In an actual application, the functions may be allocated to and completed by different functional modules according to a requirement. That is, an internal structure of the device is divided into different functional modules, to complete all or some of the functions described above. In addition, the apparatus provided in the foregoing embodiments and the method embodiments belong to the same concept. For a specific implementation process, reference may be made to the method embodiments. Details are not described herein again.

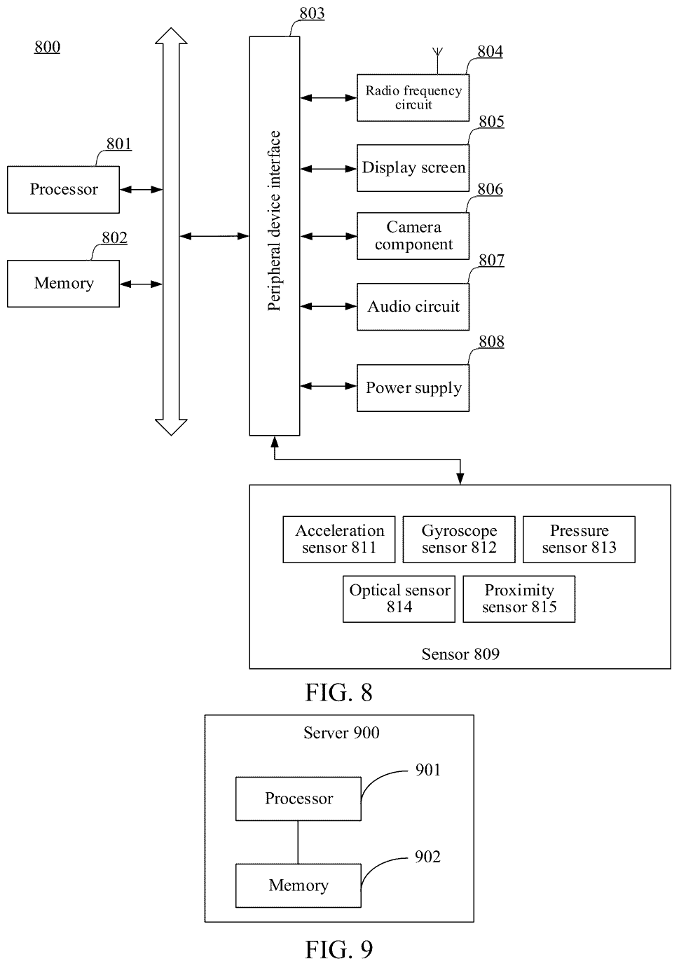

FIG. 8 shows a structural block diagram of a terminal device 800 according to an exemplary embodiment of the present disclosure. The terminal device 800 includes a processor 801 and a memory 802.

The processor 801 may include one or more processing cores, for example, a 4-core processor or an 8-core processor. The processor 801 may be implemented in at least one hardware form of a digital signal processor (DSP), a field-programmable gate array (FPGA), or a programmable logic array (PLA). The processor 801 may alternatively include a main processor and a coprocessor. The main processor is configured to process data in an awake state, and is also referred to as a central processing unit (CPU). The coprocessor is a low power consumption processor configured to process data in a standby state. In some embodiments, the processor 801 may be integrated with a graphics processing unit (GPU). The GPU is configured to render and draw content that needs to be displayed on a display screen. In some embodiments, the processor 801 may further include an artificial intelligence (AI) processor. The AI processor is configured to process computing operations related to machine learning.

The memory 802 may include one or more computer-readable storage media. The computer-readable storage medium may be non-transient. The memory 802 may further include a high-speed random access memory and a non-volatile memory, for example, one or more magnetic disk storage devices or flash storage devices. In some embodiments, the non-transient computer-readable storage medium in the memory 802 is configured to store at least one computer program, and the at least one computer program is executed by the processor 801 to implement the speech-to-text conversion method provided in the method embodiments of the present disclosure.

In some embodiments, the terminal device 800 further includes: a peripheral device interface 803 and at least one peripheral device. The processor 801, the memory 802, and the peripheral device interface 803 may be connected through a bus or a signal cable. Each peripheral device may be connected to the peripheral device interface 803 through a bus, a signal cable, or a circuit board. Specifically, the peripheral device includes: at least one of a radio frequency (RF) circuit 804, a display screen 805, a camera component 806, an audio circuit 807, and a power supply 808.

The peripheral device interface 803 may be configured to connect at least one input/output (I/O)-related peripheral device to the processor 801 and the memory 802. In some embodiments, the processor 801, the memory 802, and the peripheral device interface 803 are integrated on the same chip or circuit board. In some other embodiments, any one or two of the processor 801, the memory 802, and the peripheral device interface 803 may be implemented on a single chip or circuit board. This is not limited in this embodiment.

The RF circuit 804 is configured to receive and transmit an RF signal, also referred to as an electromagnetic signal. The RF circuit 804 communicates with a communication network and other communication devices through the electromagnetic signal. The RF circuit 804 converts an electrical signal into an electromagnetic signal for transmission, or converts a received electromagnetic signal into an electrical signal. In some embodiments, the RF circuit 804 includes: an antenna system, an RF transceiver, one or more amplifiers, a tuner, an oscillator, a digital signal processor, a codec chip set, a subscriber identity module card, or the like. The RF circuit 804 may communicate with other terminals through at least one wireless communication protocol. The wireless communication protocol includes, but is not limited to: a world wide web, a metropolitan area network, an intranet, generations of mobile communication networks (2G, 3G, 4G, and 5G), a wireless local area network and/or a wireless fidelity (WiFi) network. In some embodiments, the RF circuit 804 may further include a near field communication (NFC)-related circuit, which is not limited in the present disclosure.

The display screen 805 is configured to display a user interface (UI). The UI may include a graph, text, an icon, a video, and any combination thereof. When the display screen 805 is a touch display screen, the display screen 805 also has a capability of collecting a touch signal on or above a surface of the display screen 805. The touch signal may be inputted to the processor 801 as a control signal for processing. In this case, the display screen 805 may be further configured to provide a virtual button and/or a virtual keyboard, also referred to as a soft button and/or a soft keyboard. In some embodiments, there may be one display screen 805 disposed on a front panel of the terminal device 800. In some other embodiments, there may be at least two display screens 805, arranged on different surfaces of the terminal device 800 respectively or in a folded design. In some other embodiments, the display screen 805 may be a flexible display screen disposed on a curved surface or a folded surface of the terminal device 800. Even further, the display screen 805 may be arranged in a non-rectangular irregular pattern, that is, a special-shaped screen. The display screen 805 may be prepared by using materials such as a liquid crystal display (LCD) or an organic light-emitting diode (OLED).

The camera component 806 is configured to collect an image or a video. In some embodiments, the camera component 806 includes a front-facing camera and a rear-facing camera. Generally, the front-facing camera is disposed on a front panel of the terminal device, and the rear-facing camera is disposed on a back surface of the terminal device. In some embodiments, there are at least two rear-facing cameras, which are respectively any one of a main camera, a depth of field camera, a wide-angle camera, and a telephoto camera, to achieve a background blurring function through fusion of the main camera and the depth-of-field camera, panoramic photographing and virtual reality (VR) photographing functions through fusion of the main camera and the wide-angle camera, or other fusion photographing functions. In some embodiments, the camera component 806 may further include a flash light. The flash light may be a single color temperature flash light or a double color temperature flash light. The double color temperature flash light refers to a combination of a warm light flash light and a cold light flash light, and may be configured for light compensation at different color temperatures.

The audio circuit 807 may include a microphone and a speaker. The microphone is configured to collect sound waves of a user and an environment, and convert the sound waves into electrical signals and input the electrical signals to the processor 801 for processing, or input the electrical signals to the RF circuit 804 to implement speech communication. For the purpose of stereo collection or noise reduction, there may be a plurality of microphones, which are respectively disposed at different parts of the terminal device 800. The microphone may further be an array microphone or an omnidirectional collection microphone. The speaker is configured to convert an electrical signal from the processor 801 or the RF circuit 804 into a sound wave. The speaker may be a thin-film speaker or a piezoelectric ceramic speaker. When the speaker is a piezoelectric ceramic speaker, the speaker can not only convert an electrical signal into a sound wave audible to a human being, but also convert an electrical signal into a sound wave inaudible to a human being for ranging and other purposes. In some embodiments, the audio circuit 807 may further include an earphone jack.

The power supply 808 is configured to supply power to components of the terminal device 800. The power supply 808 may be an alternating-current power supply, a direct-current power supply, a disposable battery, or a rechargeable battery. When the power supply 808 includes a rechargeable battery, the rechargeable battery may be a wired rechargeable battery or a wireless rechargeable battery. The wired rechargeable battery is a battery charged through a wired line, and the wireless rechargeable battery is a battery charged through a wireless coil. The rechargeable battery may be further configured to support a fast charging technology.

In some embodiments, the terminal device 800 further includes one or more sensors 809. The one or more sensors 809 include, but are not limited to, an acceleration sensor 811, a gyroscope sensor 812, a pressure sensor 813, an optical sensor 814, and a proximity sensor 815.

The acceleration sensor 811 can detect magnitudes of accelerations in three coordinate axes of a coordinate system established by the terminal device 800. For example, the acceleration sensor 811 may be configured to detect components of gravity acceleration on the three coordinate axes. The processor 801 may control the display screen 805 to display a user interface in a landscape view or a portrait view according to a gravity acceleration signal collected by the acceleration sensor 811. The acceleration sensor 811 may also be configured to collect motion data of a game or a user.

The gyroscope sensor 812 can detect a body direction and a rotation angle of the terminal device 800. The gyroscope sensor 812 can collect 3D actions of the user on the terminal device 800 in cooperation with the acceleration sensor 811. Based on data collected by the gyroscope sensor 812, the processor 801 can implement the following functions: motion sensing (for example, changing the UI based on a tilt operation of the user), image stabilization during photographing, game control, and inertial navigation.

The pressure sensor 813 may be disposed at a side frame of the terminal device 800 and/or a lower layer of the display screen 805. When the pressure sensor 813 is disposed at the side frame of the terminal device 800, a holding signal of the user on the terminal device 800 may be detected. The processor 801 performs left and right hand recognition or a quick operation according to the holding signal collected by the pressure sensor 813. When the pressure sensor 813 is disposed at the lower layer of the display screen 805, the processor 801 controls an operable control on the UI interface according to a pressure operation performed by the user on the display screen 805. The operable control includes at least one of a button control, a scroll bar control, an icon control, or a menu control.

The optical sensor 814 is configured to collect ambient light intensity. In an embodiment, the processor 801 may control display brightness of the display screen 805 according to the ambient light intensity collected by the optical sensor 814. Specifically, when the ambient light intensity is relatively high, the display brightness of the display screen 805 is increased; and when the ambient light intensity is relatively low, the display brightness of the display screen 805 is decreased. In another embodiment, the processor 801 may further dynamically adjust photographing parameters of the camera component 806 according to the ambient light intensity collected by the optical sensor 814.

The proximity sensor 815, also referred to as a distance sensor, is generally disposed on the front panel of the terminal device 800. The proximity sensor 815 is configured to collect a distance between the user and the front surface of the terminal device 800. In an embodiment, when the proximity sensor 815 detects that the distance between the user and the front surface of the terminal device 800 gradually decreases, the processor 801 controls the display screen 805 to switch from a screen-on state to a screen-off state; and when the proximity sensor 815 detects that the distance between the user and the front surface of the terminal device 800 gradually increases, the processor 801 controls the display screen 805 to switch from the screen-off state to the screen-on state.

A person skilled in the art may understand that the structure shown in FIG. 8 does not constitute a limitation to the terminal device 800, and the terminal device may include more or fewer components than those shown in the figure, or some components may be combined, or a different component deployment may be used.

FIG. 9 is a schematic structural diagram of a server according to an embodiment of the present disclosure. The server 900 may vary greatly due to different configurations or performance, and may include one or more processors 901 and one or more memories 902. The one or more memories 902 store at least one computer program. The at least one computer program is loaded and executed by the one or more processors 901 to implement the speech-to-text conversion method provided in the foregoing method embodiments. For example, the processor 901 is a CPU. Certainly, the server 900 may further have components such as a wired or wireless network interface, a keyboard, an input/output interface, or the like for input and output. The server 900 may further include other components for implementing device functions. Details are not described herein.

In an exemplary embodiment, a computer-readable storage medium is further provided. The storage medium stores at least one computer program, and the at least one computer program is loaded and executed by a processor to cause an electronic device to implement any speech-to-text conversion method described above.

In some embodiments, the computer-readable storage medium may be a read-only memory (ROM), a random access memory (RAM), a compact disc read-only memory (CD-ROM), a magnetic tape, a floppy disk, an optical data storage device, or the like.

In an exemplary embodiment, a computer program or a computer program product is further provided. The computer program or the computer program product stores at least one computer program, and the at least one computer program is loaded and executed by a processor, to cause an electronic device to implement any speech-to-text conversion method described above.

“A plurality of” mentioned in the present disclosure means two or more. “And/or” describes an association relationship between associated objects and indicates that three relationships may exist. For example, A and/or B may indicate the following three cases: Only A exists, both A and B exist, and only B exists. The character “/” generally indicates an “or” relationship between the associated objects.

The sequence numbers of the foregoing embodiments of the present disclosure are merely for description purpose and do not indicate the preference of the embodiments.

The foregoing merely describes exemplary embodiments of the present disclosure, but is not intended to limit the present disclosure. Any modification, equivalent replacement, or improvement made within the principle of the present disclosure shall fall within the protection scope of the present disclosure.

What is claimed is:

1. A speech-to-text conversion method, performed by an electronic device, the method comprising:
obtaining speech information to be converted and a screen image, the screen image being an image related to the speech information and displayed on a screen during generation of the speech information;
performing speech-to-text conversion on the speech information to obtain a plurality of pieces of candidate text information;
determining target appearance indicators corresponding to the plurality of pieces of candidate text information based on the screen image, a target appearance indicator of one piece of the candidate text information representing a probability that the one piece of candidate text information corresponds to the speech information; and
selecting the candidate text information whose target appearance indicator meets a requirement from the plurality of pieces of candidate text information as converted text information of the speech information.

2. The method according to claim 1, wherein the performing speech-to-text conversion on the speech information to obtain a plurality of pieces of candidate text information comprises:
performing segmentation on the speech information to obtain a plurality of speech segments;
performing speech-to-text conversion on each speech segment to obtain a character corresponding to the speech segment; and
determining the plurality of pieces of candidate text information based on the characters corresponding to the plurality of speech segments.

3. The method according to claim 1, wherein the determining target appearance indicators corresponding to the plurality of pieces of candidate text information based on the screen image comprises:
determining screen text information based on the screen image; and
determining the target appearance indicators corresponding to the plurality of pieces of candidate text information based on the screen text information.

4. The method according to claim 3, wherein the determining screen text information based on the screen image comprises:
performing image segmentation on the screen image to obtain at least one of a text image and an object image, wherein the text image reflects a text displayed on the screen, and the object image reflects an object displayed on the screen; and
determining the screen text information based on at least one of the text image and the object image.

5. The method according to claim 4, wherein determining the screen text information based on the text image comprises:
performing text recognition on the text image to obtain first text information in the text image;
determining at least one piece of second text information based on the first text information, wherein semantics of the second text information is the same as, opposite to, or similar to semantics of the first text information; and
determining the first text information and the at least one piece of second text information as the screen text information.

6. The method according to claim 4, wherein determining the screen text information based on the object image comprises:
performing image description processing on the object image to obtain third text information, wherein the third text information describes the object in the object image;
determining at least one piece of fourth text information based on the third text information, wherein semantics of the fourth text information is the same as, opposite to, or similar to semantics of the third text information; and
determining the third text information and the at least one piece of fourth text information as the screen text information.

7. The method according to claim 3, wherein the determining the target appearance indicators corresponding to the plurality of pieces of candidate text information based on the screen text information comprises:
performing word segmentation on a piece of candidate text information to obtain words comprised in the piece of candidate text information;
determining a target appearance indicator of each word comprised in the piece of candidate text information based on the screen text information, wherein the target appearance indicator of the word represents a probability that the word is comprised in the speech information; and
determining the target appearance indicator of the piece of candidate text information based on the target appearance indicators of the words comprised in the piece of candidate text information.

8. The method according to claim 7, wherein the determining a target appearance indicator of each word comprised in the candidate text information based on the screen text information comprises:
obtaining an initial appearance indicator of each word, wherein the initial appearance indicator of the word represents a probability that the word appears in a general scenario; and
adjusting the initial appearance indicator of the word based on the screen text information to obtain the target appearance indicator of the word.

9. The method according to claim 8, wherein the screen text information comprises first text information and at least one piece of second text information; the first text information is text information corresponding to the text image in the screen image, and semantics of the second text information is the same as, opposite to, or similar to semantics of the first text information; and
the adjusting the initial appearance indicator of the word based on the screen text information to obtain the target appearance indicator of the word comprises:
determining a first appearance indicator of the word based on the first text information and the at least one piece of second text information, wherein the first appearance indicator of the word represents a probability that the word appears in the first text information and the at least one piece of second text information; and
performing weighted calculation on the first appearance indicator of the word and the initial appearance indicator of the word to obtain the target appearance indicator of the word.

10. The method according to claim 8, wherein the screen text information comprises third text information and at least one piece of fourth text information; the third text information is text information corresponding to the object image in the screen image, and semantics of the fourth text information is the same as, opposite to, or similar to semantics of the third text information; and
the adjusting the initial appearance indicator of the word based on the screen text information to obtain the target appearance indicator of the word comprises:
determining a second appearance indicator of the word based on the third text information and the at least one piece of fourth text information, wherein the second appearance indicator of the word represents a probability that the word appears in the third text information and the at least one piece of fourth text information; and
performing weighted calculation on the second appearance indicator of the word and the initial appearance indicator of the word to obtain the target appearance indicator of the word.

11. The method according to claim 8, wherein the screen text information comprises first text information, at least one piece of second text information, third text information, and at least one piece of fourth text information; the first text information is text information corresponding to the text image in the screen image, and semantics of the second text information is the same as, opposite to, or similar to semantics of the first text information; the third text information is text information corresponding to the object image in the screen image, and semantics of the fourth text information is the same as, opposite to, or similar to semantics of the third text information; and
the adjusting the initial appearance indicator of the word based on the screen text information to obtain the target appearance indicator of the word comprises:
determining a third appearance indicator of the word based on the first text information, the at least one piece of second text information, the third text information, and the at least one piece of fourth text information, wherein the third appearance indicator of the word represents a probability that the word appears in the first text information, the at least one piece of second text information, the third text information, and the at least one piece of fourth text information; and
performing weighted calculation on the third appearance indicator of the word and the initial appearance indicator of the word to obtain the target appearance indicator of the word.

12. The method according to claim 7, wherein the determining the target appearance indicator of the candidate text information based on the target appearance indicators of the words comprised in the candidate text information comprises:
obtaining a first appearance indicator of the candidate text information, wherein the first appearance indicator of the candidate text information represents a probability that the speech information is converted into the candidate text information;
determining a second appearance indicator of the candidate text information based on the target appearance indicators of the words, wherein the second appearance indicator of the candidate text information represents a probability that the candidate text information is determined based on the words; and
performing weighted processing on the first appearance indicator of the candidate text information and the second appearance indicator of the candidate text information to obtain the target appearance indicator of the candidate text information.

13. A speech-to-text conversion apparatus, comprising:
a processor and a memory, the memory having at least one computer program stored therein, and the at least one computer program being loaded and executed by the processor to cause the electronic device to implement:
obtaining speech information to be converted and a screen image, the screen image being an image related to the speech information and displayed on a screen during generation of the speech information;
performing speech-to-text conversion on the speech information to obtain a plurality of pieces of candidate text information;
determining target appearance indicators corresponding to the plurality of pieces of candidate text information based on the screen image, a target appearance indicator of one piece of the candidate text information representing a probability that the one piece of candidate text information corresponds to the speech information; and
selecting the candidate text information whose target appearance indicator meets a requirement from the plurality of pieces of candidate text information as converted text information of the speech information.

14. The apparatus according to claim 13, wherein the performing speech-to-text conversion on the speech information to obtain a plurality of pieces of candidate text information comprises:
performing segmentation on the speech information to obtain a plurality of speech segments;
performing speech-to-text conversion on each speech segment to obtain a character corresponding to the speech segment; and
determining the plurality of pieces of candidate text information based on the characters corresponding to the plurality of speech segments.

15. The apparatus according to claim 13, wherein the determining target appearance indicators corresponding to the plurality of pieces of candidate text information based on the screen image comprises:
determining screen text information based on the screen image; and
determining the target appearance indicators corresponding to the plurality of pieces of candidate text information based on the screen text information.

16. The apparatus according to claim 15, wherein the determining screen text information based on the screen image comprises:
performing image segmentation on the screen image to obtain at least one of a text image and an object image, wherein the text image reflects a text displayed on the screen, and the object image reflects an object displayed on the screen; and
determining the screen text information based on at least one of the text image and the object image.

17. The apparatus according to claim 16, wherein determining the screen text information based on the text image comprises:
performing text recognition on the text image to obtain first text information in the text image;
determining at least one piece of second text information based on the first text information, wherein semantics of the second text information is the same as, opposite to, or similar to semantics of the first text information; and
determining the first text information and the at least one piece of second text information as the screen text information.

18. The apparatus according to claim 16, wherein determining the screen text information based on the object image comprises:
performing image description processing on the object image to obtain third text information, wherein the third text information describes the object in the object image;
determining at least one piece of fourth text information based on the third text information, wherein semantics of the fourth text information is the same as, opposite to, or similar to semantics of the third text information; and
determining the third text information and the at least one piece of fourth text information as the screen text information.

19. The apparatus according to claim 15, wherein the determining the target appearance indicators corresponding to the plurality of pieces of candidate text information based on the screen text information comprises:
performing word segmentation on a piece of candidate text information to obtain words comprised in the piece of candidate text information;
determining a target appearance indicator of each word comprised in the piece of candidate text information based on the screen text information, wherein the target appearance indicator of the word represents a probability that the word is comprised in the speech information; and
determining the target appearance indicator of the piece of candidate text information based on the target appearance indicators of the words comprised in the piece of candidate text information.

20. A non-transitory computer-readable storage medium, having at least one computer program stored therein, the at least one computer program being loaded and executed by a processor of an electronic device, to cause the electronic device to implement:
obtaining speech information to be converted and a screen image, the screen image being an image related to the speech information and displayed on a screen during generation of the speech information;
performing speech-to-text conversion on the speech information to obtain a plurality of pieces of candidate text information;
determining target appearance indicators corresponding to the plurality of pieces of candidate text information based on the screen image, a target appearance indicator of one piece of the candidate text information representing a probability that the one piece of candidate text information corresponds to the speech information; and
selecting the candidate text information whose target appearance indicator meets a requirement from the plurality of pieces of candidate text information as converted text information of the speech information.
